(19) United States
(12) Patent Application Publication
(10) Pub. No.: US 2026/0327104 A1
(43) Pub. Date: Oct. 22, 2026

(54) WATER RECUPERATION SYSTEM AND METHOD FOR RECIRCULATING WATER SYSTEMS

(71) Applicant: Edward A. Bray, San Juan, PR (US)

(72) Inventor: Edward A. Bray, San Juan, PR (US)

(21) Appl. No.: 19/724,370

(22) Filed: Jun. 29, 2026

Related U.S. Application Data
(63) Continuation-in-part of application No. 16/453,286, filed on Jun. 26, 2019, now abandoned.
Application No. 16/453,286 is a continuation-in-part of application No. 14/627,070, filed on Feb. 20, 2015, now abandoned.
(60) Provisional application No. 61/942,050, filed on Feb. 20, 2014.

(51) Int. Cl. C02F 1/52; C02F 1/44; C02F 103/02

(52) U.S. Cl. CPC C02F 1/5209; C02F 1/444; C02F 2001/5218; C02F 2103/023; C02F 2209/05; C02F 2209/10; C02F 2301/043; C02F 2301/046; C02F 2303/24

(57) ABSTRACT

A system and method for recuperating blowdown or bleed water in recirculating heat-exchange systems, including boiler and cooling tower systems, are disclosed. Water is diverted from a main circulation loop when a saturation condition exceeds a threshold and directed through an off-loop treatment path. The off-loop path includes a conditioning stage employing template-assisted crystallization to promote formation of particulate mineral crystals from dissolved hardness species, followed by a filtration stage that removes at least a portion of the generated particulate matter while leaving dissolved ionic content substantially unchanged. Treated water is returned to the main circulation loop when predefined criteria are satisfied. The system may include temperature control, sensors, and a programmable control system configured to regulate diversion, treatment, and reintegration.

### CROSS-REFERENCE TO RELATED APPLICATIONS

The present application claims the benefit of priority of U.S. provisional application 61/942050, filed on Feb. 20, 2014, U.S. application Ser. No. 14/627,070, filed on Feb. 20, 2015, and is a Continuation in Part of U.S. application Ser. No. 16/453,286, filed on Jun. 26, 2019. All of the cited applications are incorporated herein by reference.

### FIELD OF INVENTION

The present disclosure relates to water treatment systems for recirculating water applications, and more particularly to a water recuperation system and method for treating blow-down water from cooling towers and boilers using conditioning and filtration processes to enable water reuse at elevated cycles of concentration.

### BACKGROUND

Water used in cooling and heating applications within buildings and facilities has become an increasingly expensive resource. Reducing water consumption can lower operational costs and provide environmental benefits.

It is conventionally understood that blow-down or bleed is the process of removing permanently a portion of the supersaturated system water that has approached a maximum acceptable level of concentration. When this happens, the water that is blown down is replaced by make-up or feedwater water with a much lower Total Dissolved Solids (TDS) level, diluting the water remaining in the main circulation line (non-blowdown water), lowering the TDS concentration.

Recirculating water systems, including cooling towers and boilers, lose water through evaporation and drift. As water evaporates from these systems, the mineral content in the remaining water increases in concentration. This concentrated blow-down water can cause scaling on equipment surfaces, potentially damaging the system. Conventionally, blow-down water is discharged into sanitary drains or sewer lines, subject to compliance with environmental regulations regarding mineral content.

In conventional recirculating water systems, increasing the cycles of concentration is commonly limited by the onset of scaling, fouling, or other instability phenomena that arise when dissolved solids exceed their solubility limits. These instability phenomena can occur as water circulates through heat-exchange equipment, boilers, or other flow-restricted components.

Various technologies have been developed to address water treatment in recirculating systems. Some approaches involve removing dissolved solids through processes such as reverse osmosis, ion exchange, dealkalization, or evaporation. However, many existing water treatment approaches may involve brine or concentrate waste streams, regeneration chemicals, high-pressure requirements, high-energy consumption, or combinations thereof.

Accordingly, improved systems and methods for treating blow-down water from recirculating water systems while reducing water discharge and makeup requirements are desired.

### SUMMARY

The present invention overcomes the disadvantages of the Prior Art providing a residue interceptor for cooling and/or refrigeration systems, wherein said residue interceptors provide wastewater in compliance with current law requirements.

Another object of the invention is to provide a water reclaim system that is easily integrated into a current or new building water system.

Yet another object of the invention is to provide a method of recuperating waste (blow-down/bleed) water comprising a water reclaim equipment, wherein said water reclaim equipment includes a water conditioning/precipitation equipment and an ultrafiltration equipment, and wherein the water in the blow-down/bleed line is redirected in a manner such that it must always go through said recuperation equipment, thus avoiding the dumping of said water into the sanitary drain.

Yet another object of the invention is to provide a System-Level Stability at Elevated Cycles of Concentration. In conventional recirculating water systems, including boiler and cooling water systems, increasing the cycles of concentration is commonly limited by the onset of scaling, fouling, or other instability phenomena that arise when dissolved solids exceed their solubility limits. These instability phenomena can occur as water circulates through heat-exchange equipment, boilers or other flow-critical components.

The current system enables stable operation at elevated cycles of concentration by preventing unstable precipitation events from interacting with the main circulation loop, therefore, preserving boilers, heat exchangers and other equipment from scaling, fouling, or other instability phenomena that arise when dissolved solids exceed their solubility limits. Rather than allowing supersaturated water to remain in or pass through the main circulation line during periods of instability, the system detects when a predetermined acceptable saturation level of dissolved solids is exceeded and diverts the affected water away from the circulation loop. This diversion isolates unstable water from heat-exchange surfaces, flow-restricted passages, and other system components that are particularly susceptible to scale initiation and deposition.

Conditioning/precipitation, and filtration of the diverted water are performed outside the main circulation loop. Dissolved solids are treated while the water is isolated from the circulating system, thereby preventing transient instability from manifesting as adherent scale or fouling within the main loop itself. It is only because the saturation level of the blowdown/bleed water has been reduced to a level consistent with stable operation, that the treated water is returned to the circulation line.

By controlling when and where instability is permitted to occur, the system decouples overall dissolved-solids concentration from the exposure of system components to unstable precipitation conditions. This architectural approach allows the system to operate reliably at higher steady-state cycles of concentration than would otherwise be achievable, reducing water discharge and makeup requirements while maintaining stable, efficient operation of the water state-changing system.

Yet another object of the invention is to use Template Assisted Crystallization (TAC) for the conditioning/precipitation process. Template Assisted Crystallization is a physical water-conditioning technology that has been developed and applied to feedwater (as opposed to bleed or blowdown water). TAC has not been considered viable for industrial applications in bleed/blowdown water as provided herein for several reasons. Media temperature limits: Polymeric media are effective only to approximately 60 °C; ceramic media to approximately 90 °C. TAC is therefore a feedwater pre-treatment technology, not an in-boiler treatment. No standard certification for boiler applications: the IAPMO Z601 scale-reduction device standard explicitly excludes commercial recirculating boiler-type applications from its scope. TAC has not been standardized or qualified for operation in high-temperature, high-pressure, or high-concentration recirculating environments. TDS unchanged: TAC does not remove dissolved solids or soften water. For high-pressure boilers requiring very low TDS makeup water, TAC alone is insufficient. Scale formation indices unaffected: Langelier Saturation Index (LSI) and Calcium Carbonate Precipitation Potential (CCPP) are unchanged after TAC treatment, meaning thermodynamic scale-forming potential is not reduced. Flow-rate limitations: TAC systems depend on adequate contact time and are constrained in high-flow industrial settings, potentially requiring complex multi-unit installations. Media contaminant sensitivity: Elevated chlorine, iron, manganese, hydrogen sulfide, copper, and certain other contaminants can damage TAC media and shorten its operational life.

Taken together, the understanding is that TAC is a feedwater pre-treatment technology intended to condition incoming water before it enters heat-exchange equipment. The incorrect conventional wisdom is that TAC could improve Cycles of Concentration only by reducing TDS in the feedwater. Cycles of Concentration can be calculated as the ratio of the amount of TDS in the system to the amount of TDS in the makeup (feedwater). The conventional wisdom was that reducing the denominator in that ratio by treating feedwater, was the most efficient way of improving COC. The present disclosure reduces the numerator instead of the denominator, using the architecture disclosed, to achieve operation with higher COC.

Therefore, a convergence of chemical, thermodynamic, operational, and certification-based considerations that regard TAC as unsuitable or ineffective for the context of the present disclosure. Further, there is no motivation to apply TAC directly to boiler blowdown streams or to recirculating systems operating at elevated cycles of concentration, since blowdown management and recycling require technologies that physically remove dissolved solids, such as reverse osmosis, ion exchange, dealkalization, or evaporation; and Physical conditioning technologies that do not reduce dissolved solids, including TAC, were thought to be ineffective or irrelevant for addressing the constraints that limit cycles of concentration in recirculating boiler and cooling-tower systems.

TAC does not employ electromagnetic fields, electric fields, or induced electrical energy to influence ion behavior, nor does it require electrical input. Accordingly, electromagnetic scale-control technologies and TAC operate through distinct and non-equivalent mechanisms, and the performance characteristics of one do not predict or suggest the behavior of the other.

When incorporated within the Bray system, TAC may be used in conjunction with downstream filtration to remove conditioned particulate matter prior to reintegration, but without reliance on chemical reaction or regeneration processes. This further distinguishes the combined architecture from chemical precipitation systems, which depend on chemical dosing and equilibrium alteration.

Studies have suggested (Lin Shen, Drinking Water Softening/Scale Prevention Technology Assessment and Performance of Template Assisted Crystallization) that ultrafiltration has no effect on the collection of TAC formed crystals. Surprisingly, the present invention uses ultrafiltration, which, as part of the method and system, allows the operation under high cycles of concentration.

Another feature of the system and method is the detection and management of incipient instability within a recirculating water system. Rather than permitting water that exceeds a predetermined saturation threshold to continue circulating through heat-exchange, boiler, chillers and other equipment and flow-critical components, the system actively detects when saturation conditions indicative of instability are approached or exceeded. When such a condition is detected, the affected water is diverted from the main circulation loop into a separate recuperation path.

This diversion isolates oversaturated or potentially unstable water from direct contact with system components that are most vulnerable to scale initiation, fouling, or deposition. As a result, transient supersaturation events—which are a primary cause of scale formation in conventional recirculating systems—are prevented from manifesting within the circulation loop itself.

By design, the system and method use architecture to perform conditioning/precipitation, and filtration of diverted water outside the circulation environment. This off-loop treatment path provides a controlled setting in which alternative conditioning technologies may be applied without subjecting the circulation loop to instability or unwanted side effects.

In this controlled environment, water temperature, residence time, and flow conditions can be maintained within ranges compatible with conditioning technologies that are unsuitable for direct use in recirculating boiler or cooling-tower loops. In particular, because the diverted water may be cooled prior to conditioning, exposure of treatment media to excessive temperature or pressure is avoided.

Within the disclosed architecture, the assumptions that previously led the prior art to exclude TAC from blowdown or high-cycle-of-concentration applications no longer apply in the same way. TAC may be applied to diverted blowdown or bleed water that has been removed from the circulation loop, rather than to water circulating through heat-exchange equipment. Conditioning may occur at temperatures compatible with TAC media, such as within approximate ranges of 40-60 °C for polymeric templates or higher for ceramic templates, without exposing the circulation system to those conditions. Any particulate matter or conditioned mineral species produced by TAC are confined to the off-loop treatment path and may be managed before reintegration.

By isolating oversaturated water prior to conditioning, the system and method removes the very conditions—direct exposure of circulating components to concentrated or unstable water—that the prior art assumed would render TAC ineffective or unsafe in recirculating systems.

The disclosed architecture further changes the analytical framework traditionally applied to cycles-of-concentration management. In conventional systems, elevated dissolved-solids concentration is assumed to translate directly into increased scale risk because that concentration is continuously experienced by heat-exchange surfaces. The system and method breaks this linkage by ensuring that concentration excursions above acceptable stability thresholds are addressed off-loop, rather than being allowed to propagate through the circulation path.

This decoupling enables the system to operate at higher steady-state cycles of concentration than would otherwise be tolerated, while maintaining stable operation of heat-exchange equipment. Within this context, conditioning technologies such as TAC contribute to managing the physical behavior of hardness species in diverted water—even though such technologies do not alter bulk thermodynamic indices—because their application is no longer constrained by direct interaction with circulation-loop components during instability events. This combination of effects enables improved stability of recirculating systems at elevated cycles of concentration.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

The accompanying drawings which are incorporated herein constitute part of the specifications and illustrate the preferred embodiment of the invention.

FIG. 1 is a diagram of the boiler water recuperation first embodiment in accordance with the principles of the present disclosure.

FIG. 2 is a diagram of the cooling tower water recuperation first embodiment in accordance with the principles of the present disclosure.

FIG. 3 is a flowchart of a method 300 for recuperating blowdown water in a recirculating heat exchange system in accordance with the principles of the present disclosure.

FIG. 4 is a block diagram of a system 400 for recuperating blowdown water in accordance with the principles of the present disclosure.

FIG. 5 is a schematic of a control system 500 in accordance with the principles of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

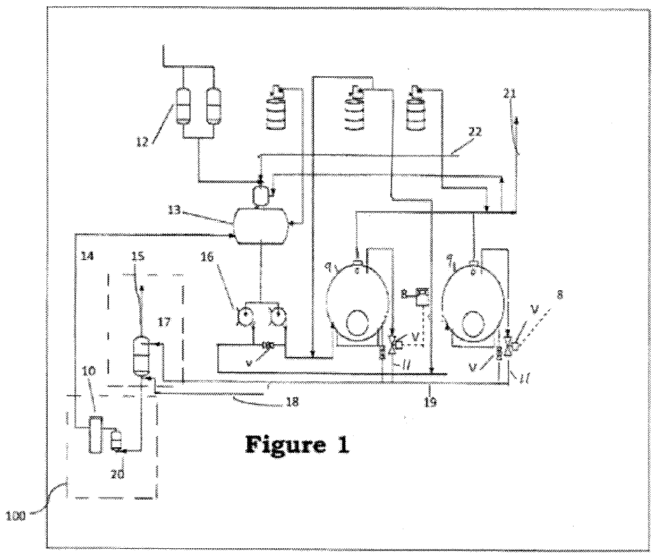

FIG. 1 is directed to the first embodiment of the present invention including a boiler system including the water recuperation equipment or water reclaims system. Mainly the boiler system of FIG. 1 provides a stream of hot water to the facilities through line 21. Several conduits 11 serve as a path from the boiler 9 to the blow-down lines 19. Water at the blow-down lines 19 is directed to a heat exchanger system using at least a pump 16 and valves V, wherein said heat exchanger system comprises a heat exchanger 17, wherein said heat exchanger may receive cooling water 18 and is provided with ventilation 15. After the water directed from the blow-down lines is exposed to the heat exchanger it is directed to the water recuperation equipment. The water recuperation equipment 100 comprises at least a water conditioning/precipitation equipment 20 coupled to water filtration equipment 10, wherein said water filtration equipment is an ultrafiltration equipment. One of the benefits of providing an ultrafiltration equipment is reusing waste (blow-down/bleed) water but at the same time removing unwanted residues that may damage the boiler system. Reusing waste (blow-down/bleed) water reduces costs and at the same time provides a better analysis on residues, more particularly on pipes use for directing said waste (blow-down/bleed) water to the sewers.

The waste (blow-down/bleed) water is treated by the water recuperation equipment and redirected through return line 14 and stored at a feed-water tank 13. Water is then pumped out of the feed-water tank 13 to the boilers by at least one feed pump 16. Condensate water 22 from the facilities and pre-treatment make-up water is directed to the feed-water tank 13 through conduit 12. The system is controlled by a control system 8 comprising PLC (Programmable Logic Controller), treatment controller, sensors and timers. The flow of water is manipulated by several valves V, wherein said valves V are controlled by controller system 8. Having water recuperation equipment 100 located after a heat exchanger 17 makes the system more efficient because more particles and residues are added to waste material due to environment exposure at this step of the process in multiple cases. Therefore locating water recuperation equipment after a heat exchanger helps to react with incoming feed-water hardness and prevent it from precipitating on the boiler metal, eliminates any suspended matter such as hardness sludge in the boiler, provides protection to the boiler, eliminates oxygen from the feed-water, and prevents corrosion of the boiler and the steam-condensate systems.

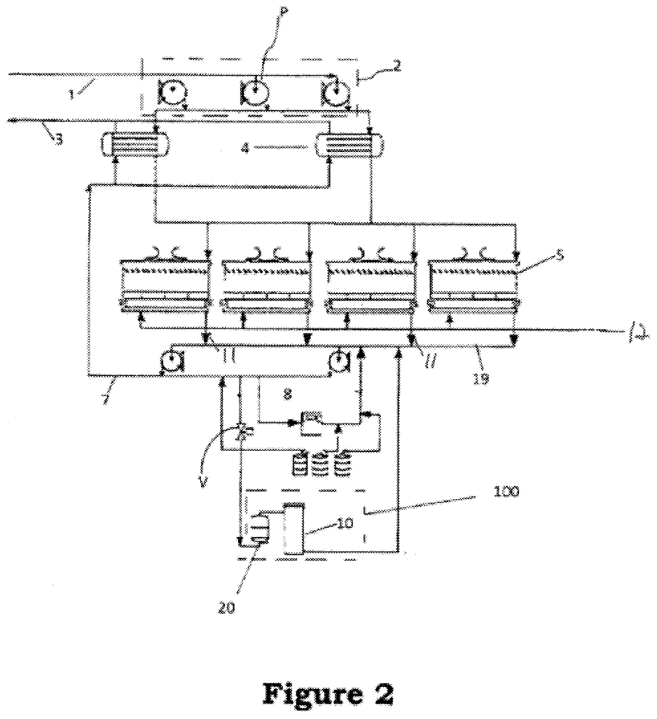

FIG. 2 is directed another system that generates waste (blow-down/bleed) water. Particularly, this exemplary embodiment of the present invention includes a cooling tower system including the water recuperation equipment 100. Water is directed from the facilities through conduit 1 toward the chiller/heat exchangers 4 by means of several pumps P. After the chiller 4 the water is redirected to the cooling towers 5. Several conduits 11 serve as a path from the cooling tower to the blow-down lines that are directed to a water recuperation equipment. Pre-treatment make-up water is available through conduit 12. Similar to the previous embodiment, the water recuperation equipment comprises at least a water conditioning/precipitation equipment 20 coupled to a water filtration equipment 10, as mentioned above. The water is treated by the water recuperation equipment and redirected via return line 7 to the chillers 4 before reaching the facilities through conduit 3. The system is controlled by a control system 8 comprising PLC, treatment controller, sensor and timers. The flow of water is manipulated by several valves V also controlled by control system 8. The control system 8 generates signals in order to open or close the valves depending on the reading of several sensor, wherein said reading is compared to a predetermined value. The values V, program for the controlled system 8 and type of sensor may vary depending on the task.

Similar to the first embodiment the location of the water recuperation equipment 100 is important since the second embodiment system will be more efficient when the particles and residues are added to waste material due to environment exposure are eliminated on the presented process in multiple cases.

Both embodiments num. 1 and num. 2, can incorporate the use of TAC in the water conditioning/precipitation step. When implemented within the present system and method, TAC is not applied to the circulating boiler or cooling-tower loop itself, but rather to diverted blowdown or bleed water within the off-loop recuperation path 19, in both embodiments(FIGS. 1 and 2), and in close association with downstream filtration 10, in both embodiments (FIGS. 1 and 2). Contrary to the conventional wisdom, this placement is significant because it ensures that crystals nucleated at the template surfaces and beyond which achieve the sizes close or beyond ultrafiltration pore size range are removed prior to reintegration of the bleedwater, thereby preventing those particles from entering the main circulation loop and subsequently contacting heat-exchange surfaces, boilers and chillers. Ultra filtration does not capture dissolved ions (Ca²⁺, Mg²⁺, Na²⁺, Cl⁻), nor does it reduce TDS by itself or change LSI/CCPP.

The disclosed system and method fundamentally change the engineering context in which TAC may be applied. Whereas the prior art evaluates TAC in isolation—typically within feedwater treatment paradigms, the disclosed architecture introduces embodiments with structural and operational framework that decouples bulk water concentration from exposure of system components (like boilers, chillers and heat exchanges) to instability conditions by foregoing equilibrium-based conditions applicable to recirculating systems that fail to isolate bleed water for treatment. This architectural change enables new applications of conditioning technologies that the prior art had previously deemed unsuitable.

Within this architecture, TAC may be employed as a conditioning step, applied to diverted blowdown or bleed water under controlled temperature and flow conditions, thereby enabling physical modification of hardness species without exposing circulation-loop components to unstable precipitation events.

The disclosed system and method fundamentally change the engineering context in which TAC may be applied. Whereas the prior art evaluates TAC in isolation—typically within feedwater treatment paradigms, the disclosed architecture introduces embodiments with structural and operational framework that decouples bulk water concentration from exposure of system components (like boilers, chillers and heat exchanges) to instability conditions by foregoing equilibrium-based conditions applicable to recirculating systems that fail to isolate bleed water for treatment. This architectural change enables new applications of conditioning technologies that the prior art had previously deemed unsuitable.

As shown in the previous exemplary embodiments, the configuration of the components in the water recuperation equipment must always be the same in order for the method of the present invention to be effective. First, the waste (blow-down/bleed) water goes through a precipitation/conditioning process to separate solids and then to a filtration process to remove said solids, reducing the conductivity levels of said water and making it usable for the water state changing system again. It is necessary for the water to pass through the precipitation/conditioning process before being filtered, as the separated solids need to be discarded before allowing the water back into the main circulation line to avoid damage to the rest of the equipment in the system. This method avoids the dumping of oversaturated water through a drain and reduces the amount of make-up water necessary by a system, without the pressure requirements of osmosis or chemical regeneration. Using this method, once the control system determines that the water in the system has reached a specified level of saturation of dissolved solids, instead of dumping and replacing said water, it is reused by the system.

The absence of measurable change in TDS, dissolved hardness ion concentration, and equilibrium saturation indices confirms that TAC does not operate by removing ions from solution or by shifting bulk chemical equilibria. Accordingly, TAC is not properly characterized as a water-softening process, nor as a desalination or demineralization technology. Instead, TAC functions as a physical water-conditioning process that alters the physical state and nucleation behavior of scale-forming minerals without substantially changing bulk water chemistry.

More specifically, TAC promotes the formation of microscopic mineral crystals in the bulk water phase by providing engineered nucleation sites on template media. These crystals form at the template surface and are subsequently released into suspension, where they remain as discrete particulate matter rather than adhering to metallic surfaces or other substrates. In this way, TAC modifies the kinetics and pathways of mineral precipitation, favoring bulk-phase crystal growth over surface-based heterogeneous nucleation, even though the thermodynamic conditions for scale formation remain unchanged.

The integration of TAC within the disclosed system and method may be implemented in a variety of configurations consistent with the architectural principles described herein. The following embodiments are provided as illustrative examples of such implementations and are not intended to limit the scope of the invention.

In some embodiments, water diverted from the circulation loop is cooled prior to entering the TAC treatment stage. Cooling may be achieved through heat exchange, chillers, mixing with lower-temperature streams, or other suitable means. The resulting water temperature may be controlled to fall within an operating range compatible with TAC media, including, by way of example, approximately 40 °C to 60 °C for polymeric template media or higher for ceramic template media. By conditioning water at reduced temperature within the off-loop path, the system enables the use of TAC in environments where direct application to the circulating system would otherwise be impractical due to temperature or pressure constraints.

Following TAC conditioning, the treated water is directed to a filtration system configured to remove at least a portion of the particulate material generated during nucleation. Suitable filtration systems may include, without limitation, any ultrafiltration equipment.

In some embodiments, filtration is configured to remove a portion, but not necessarily all, of the particulate matter generated by TAC. The filtration cutoff, operating pressure, flow rate, and other parameters may be selected to allow a controlled fraction of particles—such as sub-micron or nano-scale crystals—to remain suspended in the treated water. By retaining a controlled population of such particles, the system may provide a source of seed crystals that influence subsequent nucleation behavior after reintegration, that preempts deposition in the mainline equipment.

Treated water exiting the filtration stage can be returned to the main circulation loop after completion of one pass or after several passes through the conditioning and separation stages.

In certain embodiments, reintegration is controlled to occur only after one or more criteria are met, including: reduction of saturation level to within an acceptable threshold; completion of at least one conditioning and filtration cycle; and confirmation of acceptable water quality parameters.

The operation of the diversion, conditioning, filtration, and reintegration steps may be governed by a control system configured to monitor system parameters and manage flow paths accordingly. In various embodiments, the control system may: monitor saturation indicators such as conductivity, hardness, alkalinity, or other relevant parameters; initiate diversion of water from the circulation loop when threshold conditions are met; control flow through TAC and filtration stages; and regulate reintegration based on defined criteria.

The control system may include sensors, programmable controllers, and associated logic configured to coordinate operation of the system components in accordance with the principles described herein.

The TAC conditioning stage may be implemented as a modular unit integrated into a broader treatment system. Multiple TAC units may be arranged in series or parallel to accommodate varying flow rates or system capacities. Similarly, filtration stages may be configured as single-stage or multi-stage systems with varying degrees of separation.

The system may also be implemented in configurations where TAC is combined with additional treatment technologies within the off-loop path, provided that such configurations remain consistent with the architectural principle of isolating unstable water from the main circulation loop prior to treatment.

Because the system allows operation at higher cycles of concentration while maintaining stability, the volume of water that must be discharged as blowdown or bleed is reduced. Correspondingly, the demand for make-up water introduced into the system is also reduced. These effects are achieved not by continuous removal of dissolved solids through energy-intensive or chemically intensive processes, but by managing the timing and location of precipitation/conditioning and deposition.

In certain embodiments, the system may enable a reduction in blowdown frequency or volume relative to comparable systems operating under conventional equilibrium-limited conditions, thereby improving overall water-use efficiency.

Blowdown water in boiler and similar systems typically carries a significant amount of thermal energy. By reducing the volume of blowdown required to maintain system operation, the disclosed system correspondingly reduces the loss of heat associated with discharged water. This effect may improve the overall thermodynamic efficiency of the system and reduce energy consumption required to maintain operating conditions.

By altering the pathways through which precipitation occurs and by limiting the exposure of sensitive system components to supersaturated water, the disclosed system reduces the incidence of adherent, hard-scale formation on heat-exchange surfaces. In embodiments incorporating TAC, the formation of less adherent crystalline structures and their preferential growth in the bulk fluid may further reduce deposition strength and density.

Even in cases where deposition occurs, such deposits may be less tenacious and more readily removed through normal operation or maintenance, resulting in reduced fouling and improved heat-transfer performance.

The effects described herein are achieved without reliance on technologies that require significant removal of dissolved material from the water, such as ion exchange, reverse osmosis, or thermal evaporation. As a result, the system avoids: brine or concentrate waste streams associated with demineralization processes; regeneration chemicals required for ion-exchange resins; and high-pressure or high-energy requirements associated with membrane or thermal separation systems.

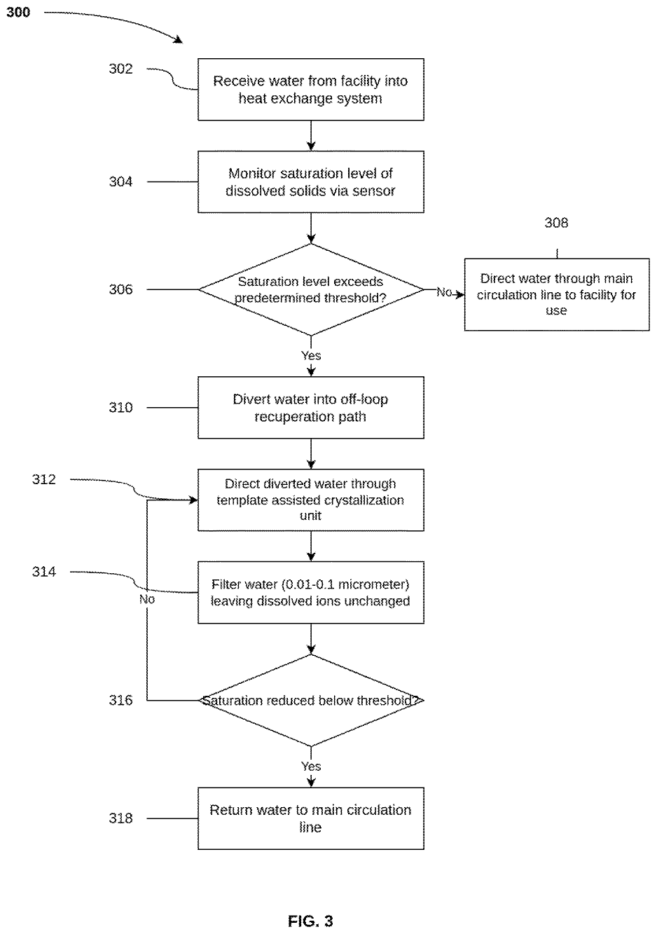

FIG. 3 illustrates a flowchart of a method 300 for recuperating blowdown water in a recirculating heat exchange system. The method 300 includes a step 302 of receiving water from a facility into a heat exchange system, and a step 304 of monitoring a saturation level of dissolved solids in the water via at least one sensor. A decision 306 determines whether the saturation level exceeds a predetermined threshold. When it does not, a step 308 directs the water through the main circulation line to the facility for use. When the threshold is exceeded, a step 310 diverts the water into an off-loop recuperation path, a step 312 directs the diverted water through a template assisted crystallization unit, and a step 314 filters the water to remove particulate material in the 0.01 to 0.1 micrometer range while leaving dissolved ionic species unchanged. A decision 316 determines whether the saturation level has been reduced below the threshold; if not, the water is recirculated through the conditioning and filtration steps, and if so, a step 318 returns the water to the main circulation line.

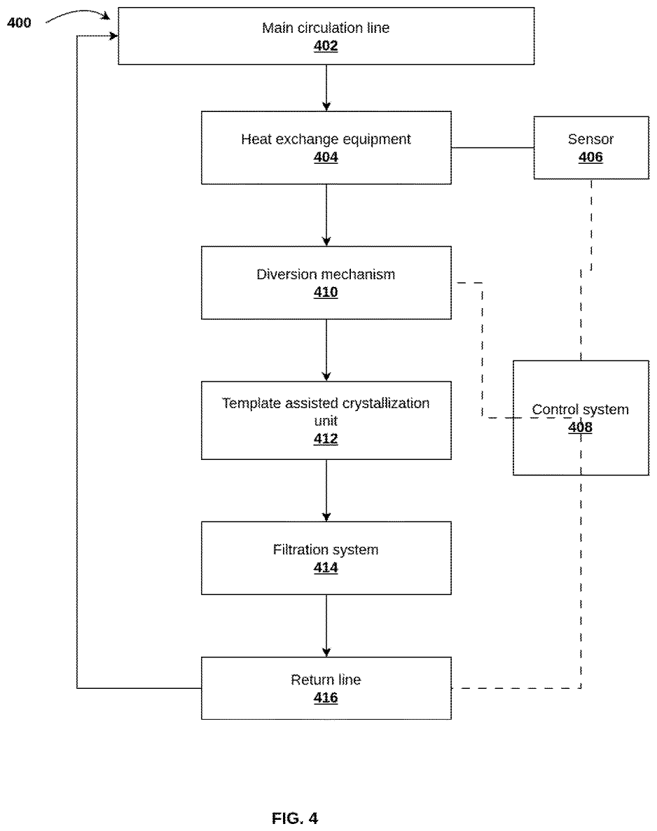

FIG. 4 illustrates a block diagram of a system 400 for recuperating blowdown water. The system 400 comprises a main circulation line 402 having heat exchange equipment 404, a sensor 406 configured to measure a saturation level of dissolved solids, and a control system 408 configured to establish a predetermined saturation threshold and monitor the saturation level. A diversion mechanism 410 diverts water from the main circulation line 402 into an off-loop recuperation path when the saturation level exceeds the threshold. The off-loop path includes a template assisted crystallization unit 412 and a downstream filtration system 414, followed by a return line 416 that returns treated water to the main circulation line 402 after the saturation level has been reduced below the threshold. The control system 408 communicates with the sensor 406, diversion mechanism 410, and return line 416.

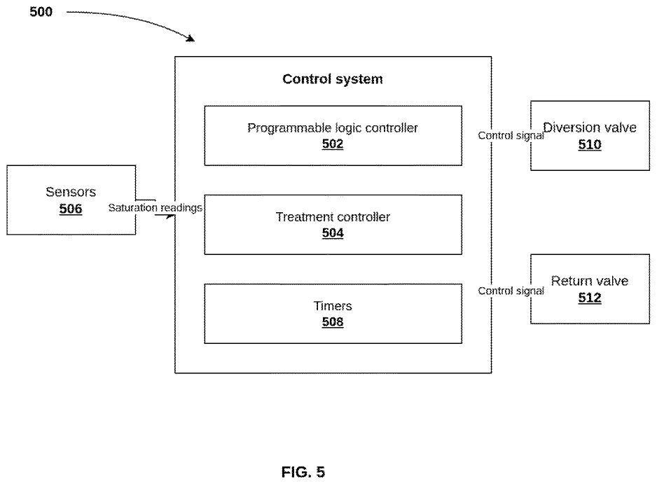

FIG. 5 illustrates a schematic of the control system 500. The control system 500 includes a programmable logic controller 502, a treatment controller 504, and timers 508. Sensors 506 provide saturation readings to the control system 500, which generates control signals to actuate a diversion valve 510 and a return valve 512, thereby governing diversion of water into the off-loop recuperation path and reintegration of treated water into the main circulation line.

While the invention has been described as having a preferred design, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

A number of implementations have been described. Nevertheless, it will be understood that various modifications may be made without departing from the spirit and scope of the disclosure. Accordingly, other implementations are within the scope of the following claims.

1. A method for recuperating blowdown water, comprising the steps of:
receiving water in a heat exchange system from a facility;
the heat exchange system comprising at least a main circulation line and a heat exchange equipment;
establishing, through a control system, a predetermined saturation threshold indicative of instability conditions in the water;
monitoring, through at least one sensor, a saturation level of dissolved solids in the water circulating through the main circulation line;
when the saturation level is within the predetermined saturation threshold, directing the water through the main circulation line to the facility for use;
when the saturation level exceeds the predetermined saturation threshold, diverting the water from the main circulation line into an off-loop recuperation path to isolate the diverted water from the heat exchange system, the recuperation path comprising:
(a) directing the diverted water through a template assisted crystallization unit;
(b) immediately downstream of the template assisted crystallization unit, directing the water through a filtration system to remove particulate material having a size in the range of 0.01 to 0.1 micrometers while leaving dissolved ionic species unchanged; and
(c) returning the water from the recuperation path to the main circulation line only after the saturation level has been reduced to a level below the predetermined saturation threshold.

2. The method of claim 1, wherein the heat exchange equipment comprises at least a cooling tower.

3. The method of claim 1, wherein the heat exchange equipment comprises a boiler system.

4. The method of claim 1, wherein the saturation level is measured based on electrical conductivity of the water.

5. The method of claim 1, wherein the saturation level is determined using at least one parameter selected from total dissolved solids, calcium hardness, alkalinity, or conductivity.

6. The method of claim 1, wherein the diverting is automatically controlled by the control system based on input of the at least one sensor.

7. The method of claim 1, wherein the template assisted crystallization unit operates without chemical reagent addition.

8. The method of claim 1, wherein the template assisted crystallization unit operates without application of electromagnetic or electric fields.

9. The method of claim 1, wherein the template assisted crystallization unit does not materially reduce total dissolved solids or alter equilibrium saturation indices of the water.

10. The method of claim 1, wherein the filtration system comprises ultrafiltration membranes.

11. The method of claim 1, wherein the filtration system removes particulate material formed during crystallization while permitting dissolved ionic species to remain in solution.

12. The method of claim 1, wherein the filtration system removes only a portion of the particulate material, allowing a fraction of particles smaller than 0.01 micrometers to remain suspended in the water.

13. The method of claim 1, wherein the diverted water is passed through the template assisted crystallization unit and filtration system more than once prior to the returning the water from the recuperation path to the main circulation line.

14. The method of claim 1, wherein returning the water from the recuperation path to the main circulation line is permitted only after confirmation by the control system that the saturation level has fallen below the predetermined saturation threshold.

15. The method of claim 1, wherein diverting of water reduces exposure of heat exchange equipment to water exceeding the predetermined saturation threshold.

16. The method of claim 1, wherein the diverted water is maintained at a temperature between approximately 40 °C and 60 °C prior to or during processing by the template assisted crystallization unit.

17. A system for recuperating blowdown water in a heat exchange system, comprising:
a main circulation line comprising at least one heat exchange equipment;
at least one sensor configured to measure a saturation level of dissolved solids in water circulating through the main circulation line;
a control system configured to establish a predetermined saturation threshold indicative of instability conditions and to monitor the saturation level;
a diversion mechanism configured to divert water from the main circulation line into an off-loop recuperation path when the saturation level exceeds the predetermined saturation threshold;
a template assisted crystallization unit disposed within the off-loop recuperation path;
a filtration system positioned downstream of the template assisted crystallization unit, configured to remove particulate material having a size in the range of 0.01 to 0.1 micrometers while leaving dissolved ionic species unchanged; and
a return line configured to return the water to the main circulation line after the saturation level has been reduced below the predetermined saturation threshold.

18. The system of claim 17, wherein the control system is configured to prevent return of diverted water until the saturation level falls below the predetermined saturation threshold.

19. A method of operating a recirculating heat exchange system, consisting of:
receiving water in the heat exchange system from a facility;
circulating the water through a main circulation line comprising at least one heat exchange equipment;
establishing, through a control system, a predetermined saturation threshold indicative of instability conditions in the water;
monitoring, through at least one sensor, a saturation level of dissolved solids in the water circulating through the main circulation line, wherein the saturation level is determined based on at least one parameter selected from conductivity, total dissolved solids, calcium hardness, or alkalinity;
when the saturation level is within the predetermined saturation threshold, directing the water through the main circulation line for continued use;
when the saturation level exceeds the predetermined saturation threshold, diverting the water from the main circulation line into an off-loop recuperation path to isolate the diverted water from the heat exchange equipment;
directing the diverted water through a template assisted crystallization unit configured to promote formation of crystalline particles while operating without chemical reagent addition, without application of electromagnetic or electric fields, and without materially reducing total dissolved solids or altering equilibrium saturation indices of the water;
maintaining the diverted water at a temperature between approximately 40 °C and 60 °C prior to or during passage through the template assisted crystallization unit;
directing the diverted water immediately downstream of the template assisted crystallization unit through a filtration system comprising ultrafiltration membranes to remove particulate material having a size in the range of approximately 0.01 to 0.1 micrometers while permitting dissolved ionic species to remain in solution;
removing at least a portion of particulate material formed during crystallization while allowing a fraction of particles smaller than 0.01 micrometers to remain suspended in the water;
returning the water from the off-loop recuperation path to the main circulation line only after the saturation level has been reduced to a level below the predetermined saturation threshold, as confirmed by the control system;
wherein diversion of water reduces exposure of the heat exchange equipment to water exceeding the predetermined saturation threshold.
